(19) United States
(12) Patent Application Publication
(10) Pub. No.: US 2026/0194163 A1
(43) Pub. Date: Jul. 9, 2026

(54) PIPE SUPPORT APPARATUS AND METHOD OF ASSEMBLING A PIPE SUPPORT APPARATUS WITH AN ELEMENT CONTAINER REMOVABLY SECURED IN A BRACKET

(71) Applicant: Sioux Chief Mfg. Co., Inc., Kansas City, MO (US)

(72) Inventors: Brian E. Ismert, Belton, MO (US); Cory Adams, Raymore, MO (US)

(73) Assignee: Sioux Chief Mfg. Co., Inc., Kansas City, MO (US)

(21) Appl. No.: 19/441,448

(22) Filed: Jan. 6, 2026

Related U.S. Application Data
(60) Provisional application No. 63/742,761, filed on Jan. 7, 2025.

(51) Int. Cl. F16L 3/10

(52) U.S. Cl. CPC F16L 3/1091

(57) ABSTRACT

A pipe clamp including a base member having a central receiver and legs, a keeper block engageable with the base member, and a resilient insert receivable within the central receiver. The pipe clamp is usable in combination with a mounting bracket having walls defining a channel and opposing engagement features with which the legs of the base member are engageable. The resilient insert includes a protruding feature configured to engage the base member when the resilient insert is advanced into the central receiver. A flexible container containing clamp assembly elements may be positioned between the mounting bracket and at least one clamp base member, with a first portion of the container received within the channel of the mounting bracket and a second portion extending outward therefrom. Methods of assembling the pipe support apparatus are also disclosed.

### CROSS-REFERENCE TO RELATED APPLICATIONS

This application claims the benefit of U.S. Provisional Patent Application No. 63/742,761, filed January 7, 2025, the disclosure of which is hereby incorporated herein in its entirety by reference.

### FIELD OF THE INVENTION

This invention relates to a pipe support apparatus with a pipe clamp assembly and a slider bracket, and a method of assembling such an apparatus.

### BACKGROUND

Manufacturers of plumbing supplies are constantly seeking to improve the convenience of their products for use by plumbers, and to improve the efficiency of producing and distributing their products. Plumbers rely on pipe supports to fix the position of pipes extending through walls and support pipes or plumbing lines through bends and mitigate undesirable tension during plumbing installations such as sinks, tubs, showers, or lavatories. Pipe supports may comprise multiple components and are commonly received by plumbing brackets which may, in some use cases, be telescopically extended or retracted to facilitate universal mounting between adjacent studs or other building frame members. Known combinations of pipe supports and brackets are produced by pre-installation processes, including a sliding process by which some components of the pipe supports are slid into a plumbing bracket, and a stabbing process by which a receptacle holding some components of the pipe supports is forcibly paired to the plumbing bracket. The sliding and stabbing processes require substantial resources, including additional equipment, complexity, and time to prepare the pipe supports and brackets for distribution, resulting in increased equipment costs, personnel costs, and other overhead costs, which are passed on to plumbers and, ultimately, to consumers.

### SUMMARY

Embodiments of the invention are defined by the claims below, not this summary. A high-level overview of various aspects of the invention is provided here to introduce a selection of concepts that are further described in the Detailed Description section below. This summary is not intended to be used in isolation to determine the scope of the claimed subject matter. In brief, this disclosure describes among other things, a pipe support apparatus that supports plumbing pipes, and a method of assembling the same.

A pipe support apparatus is provided for supporting elongate members within a building structure. The apparatus includes a mounting bracket having a plurality of walls defining a channel and a plurality of opposing engagement features. In certain embodiments, the mounting bracket includes a first bracket section and a second bracket section that are slidable or telescopically extendable and retractable relative to each other to accommodate different mounting configurations. One or more clamps are loadable into the mounting bracket, with each clamp including a base member having a central receiver extending therethrough and a pair of depending legs engageable with at least some of the engagement features of the mounting bracket. Each clamp further includes a keeper block engageable with the base member, and a resilient insert receivable within the central receiver.

The resilient insert includes a protruding feature extending outward therefrom, with the protruding feature configured to engage the base member when the resilient insert is advanced into the central receiver. In certain embodiments, the resilient insert includes opposing first and second surfaces, at least one of which is slidable relative to the base member as the resilient insert is advanced into and received within the central receiver. In further embodiments, the protruding feature is formed proximate a bottom surface of the resilient insert and may comprise a wedge having a sliding surface extending upward and outward to an abutment surface. The resilient insert may further include a curved receiving surface positioned opposite the bottom surface.

The pipe support apparatus may include a flexible container including a first portion and a second portion. The first portion of the flexible container is positioned within the channel of the mounting bracket and extending between a floor of the mounting bracket and the depending legs of at least one clamp base member. The second portion of the flexible container extends outward from the channel of the mounting bracket, and contains one or more clamp assembly elements. In certain embodiments, the clamp assembly elements contained within the second portion of the flexible container include resilient inserts and keeper blocks corresponding in number to a number of clamp base members intended to be loaded into the mounting bracket.

In another aspect, a method of assembling the pipe support apparatus is provided. The method includes positioning one or more mounting brackets on a positioning surface such that the channels of the mounting brackets are accessible to receive the base members, positioning one or more flexible containers adjacent to each mounting bracket such that a first portion of each container extends adjacent to the channel of a corresponding mounting bracket, and loading one or more base members into each mounting bracket such that depending legs of at least one base member depress the first portion of a corresponding container into the channel of each mounting bracket.

### DESCRIPTION OF THE DRAWINGS

Illustrative embodiments of the invention are described in detail below with reference to the attached drawing figures, and wherein:

FIG. 1 is a perspective view of a pipe support apparatus in accordance with an embodiment of the invention, viewed from above and to the left and depicted with a slider bracket mounted between adjacent building members and with a container removed for clarity;

FIG. 2 is a perspective view of the pipe support apparatus of FIG. 1, viewed from below and to the right;

FIG. 3 is an exploded, perspective view of a clamp assembly of the pipe support apparatus of FIG. 1, viewed from above and to the left;

FIG. 4 is a fractional, side elevational view of the of the pipe support apparatus of FIG. 1, viewed from the left and depicted with a container removed for clarity;

FIG. 5 is a flowchart showing steps of a method of assembly a pipe support apparatus.

### DETAILED DESCRIPTION

The following detailed description references the accompanying drawings that illustrate specific embodiments in which the invention can be practiced. The embodiments are intended to describe aspects of the invention in sufficient detail to enable those skilled in the art to practice the invention. Other embodiments can be utilized, and changes can be made without departing from the scope of the invention. The following detailed description is, therefore, not to be taken in a limiting sense. The scope of the invention is defined only by the appended claims, along with the full scope of the equivalents to which such claims are entitled.

In this description, references to “one embodiment,” “an embodiment, or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the technology can include a variety of combinations and/or integrations of the embodiments described herein.

Directional references may be used herein for convenience in reference only and should not be interpreted in a limiting sense. For example, the words “above,” “below,” “rightwardly,” and “leftwardly” will refer to directions in the drawings to which reference is made, and the words “inwardly” and “outwardly” will refer to directions toward and away from, respectively, the geometric center of the embodiment being described and designated parts thereof. The words “forwardly” and “rearwardly” will refer to directions toward the front and back, respectively, of the embodiment being described and designated parts thereof. The terms “about” or “approximately” as used herein denote deviations from the exact value by +/- 10%, preferably by +/- 5%, and/or deviations in the form of changes that are insignificant to the described function. Said terminology will include the words specifically mentioned, derivatives thereof, and words of a similar import.

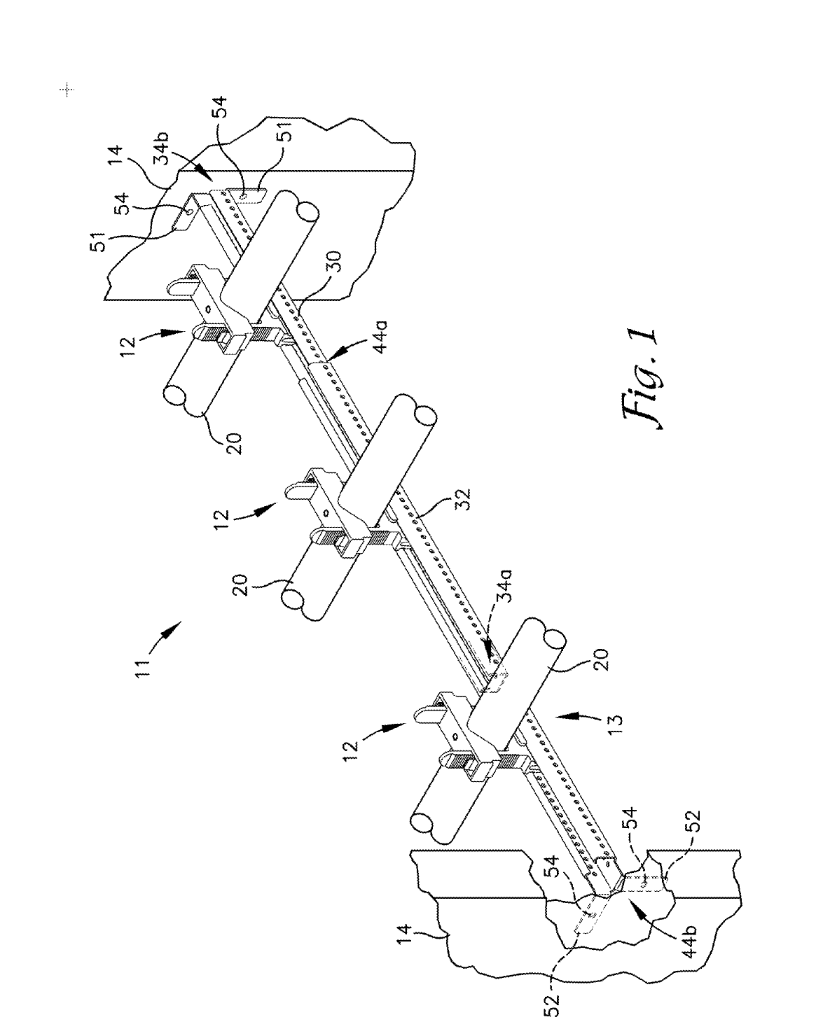

Embodiments of a pipe support apparatus 11 comprising one or more double ratchet arm pipe clamp assemblies 12 and a bracket 13 are shown and described herein. The double ratchet arm pipe clamp assembly 12 may also be referred to as a pipe clamp assembly 12 and is an improvement over double ratchet arm pipe clamp assemblies disclosed in U.S. Patent No. 6,402,096 assigned to Sioux Chief Mfg. Co., Inc. of Kansas City, MO (the “’096 Patent”) and U.S. Patent No. 6,446,915, also assigned to Sioux Chief Mfg. Co., Inc. of Kansas City, MO (the “’915 Patent”), each of which discloses a pipe clamp assembly having a base member, a keeper block, and a resilient insert having a base portion with a first footprint and an elongate upper portion with a second footprint, the first footprint larger than the second footprint and the first and second footprints enabling the resilient insert to be received within the base member. The disclosure provided by the ’096 Patent and the ’915 Patent with respect to such pipe clamp assemblies is incorporated herein by reference. The bracket 13 may be a plumbing slider bracket 13 of the type constructed for mounting between adjacent building members, such as the wall studs 14 shown in FIG. 1. It is foreseen that the plumbing slider bracket 13 may comprise first and second bracket sections which are U-shaped in cross-section and have inwardly turned shoulders, with the first bracket section slightly smaller in dimension than the second bracket section such that the first bracket section may be slidable to fit within the second bracket section. The first bracket section may therefore be described as telescopically receivable within the second bracket section, as disclosed in the ’096 Patent and the ’915 Patent. The disclosure provided by the ’096 Patent and the ’915 Patent with respect to such plumbing slider brackets is incorporated herein by reference.

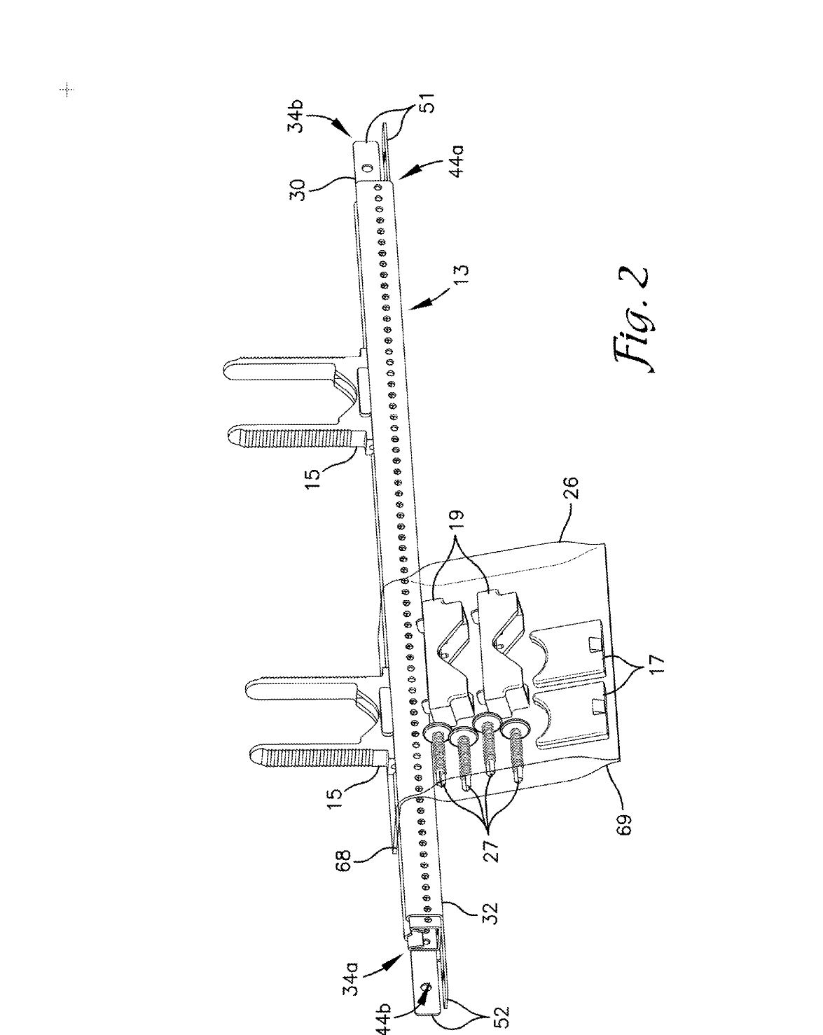

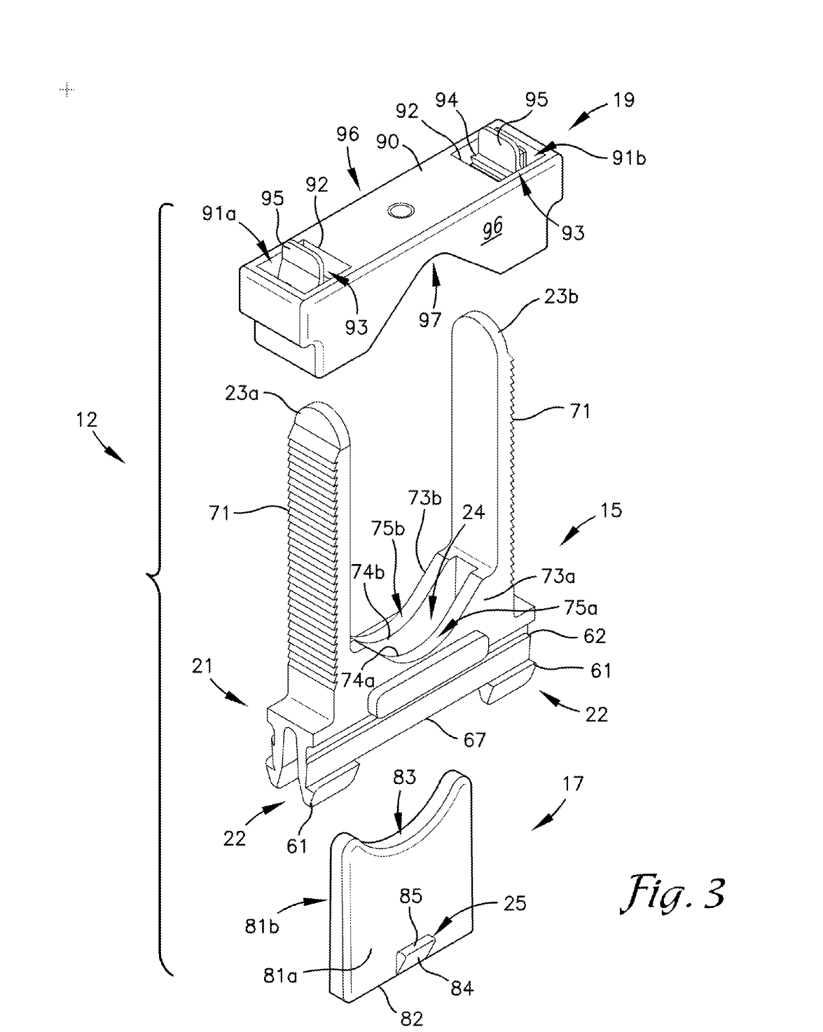

FIGS. 1-4 show a pipe support apparatus 11 including a plurality of double ratchet arm pipe clamp assemblies 12 configured to be installed in a plumbing slider bracket 13 of the type constructed for mounting between adjacent building members, such as wall studs 14. As best seen in FIG. 3, each double ratchet arm pipe clamp assembly 12 is generally of a multi-part construction and includes a clamp base member or base member 15, a resilient insert 17, and a keeper block or clamping member 19 which is engageable with the base member 15 and with the resilient insert 17 to clamp a pipe 20 therebetween. The base member 15 includes a substantially rectangular clamp base frame 21 having first and second depending legs 22 extending downward therefrom and first and second elongated ratcheting arms 23a and 23b extending upward therefrom. A central aperture or receiver 24 formed in the clamp base frame 21 extends between the first and second depending legs 22 and is sized to receive the resilient insert 17, with the resilient insert 17 including one or more protrusions or protruding features 25 for engagement with corresponding features of the clamp base frame 21 as will be described in greater detail herein. The depending legs 22 of at least one base member 15 are loaded into the slider bracket 13 such that a parts-containing bag or container 26 may be removably secured between the base member 15 and the slider bracket 13. The container 26 is configured to contain various elements of the clamp assemblies 12, including resilient inserts 17, keeper blocks 19, and screws 27 (see FIG. 2), and other foreseen elements such as base members 15; the contents of the container 26 may be referred to collectively or individually as “assembly elements” or “clamp assembly elements.”

Referring to FIGS. 1, 2, and 4, the slider bracket 13 includes an inner bracket section 30 and an outer bracket section 32 which are each substantially U-shaped in cross-section, with the inner bracket section 30 being slightly smaller in dimension than the outer bracket section 32, thereby allowing the inner bracket section 30 to be telescopically extended out of, or retracted into and received within, the outer bracket section 32. The inner bracket section 30 extends between an inner end 34a and an outer end 34b and includes a first wall or floor 35 connecting first and second sidewalls 36 and 37. The first and second sidewalls 36 and 37, which may be referred to as front and rear walls 36 and 37 depending on how the slider bracket 13 is oriented relative to studs 14, each have a respective inwardly turned engagement feature, shoulder, or flange 38 which extends inward and downward from an extremity 39 of the respective front and rear walls 36 and 37 toward the floor 35. The inwardly turned engagement features 38 are bent or slope inward and downward approximately 150 to 180 degrees from the respective first sidewall 36 or second sidewall 37 from which they each extend toward the floor 35. Each inwardly turned engagement feature 38 includes a downwardly oriented face or edge 40 which runs along the length of the inner bracket section 30 within the receiving channel formed by the first and second sidewalls 36 and 37 and the floor 35.

Similarly, the outer bracket section 32 also extends between an inner end 44a and an outer end 44b and includes a floor 45 connecting first and second sidewalls 46 and 47. Each of the first and second sidewalls 46 and 47 has a respective inwardly turned engagement feature, shoulder, or flange 48 which extends inward and downward at an angle of approximately 120 to 150 degrees relative to a respective one of the first and second sidewalls 46 and 47 from an extremity 49 thereof. Each inwardly turned engagement feature 48 includes a downwardly oriented face or edge 50 which extends along the length of the outer bracket section 32 within the channel formed by the first and second sidewalls 46 and 47 and the floor 45.

The slider bracket 13 also includes at least one, and preferably two matching, flexible tabs 51 which are connected to and extend outward from the outer end 34bof the inner bracket section 30, and at least one, and preferably two matching, flexible tabs 52 which are connected to and extend outward from the outer end 44bof the outer bracket section 32. The tabs 51 and 52 may, respectively, extend outward from the floors 35 and 45, the first sidewalls 36 and 46, the second sidewalls 37 and 47, or any combination thereof. The tabs 51 and 52 preferably include a number of pre-formed holes 54 sized to accommodate fasteners, such as the screws 27. In a preferred embodiment, the screws 27 are held in the container 26 (see FIG. 2) for use by plumbers in the field; it is foreseen that the screws 27 may be factory “pre-loaded” into the holes 54 in the tabs 51 and 52. The tabs 51 and 52 are sufficiently flexible to be easily bent to an angle of at least 90 degrees, or may alternatively be left in their extended positions to allow the slider bracket 13 to be secured to various surfaces of adjacent building members, such as wall studs.

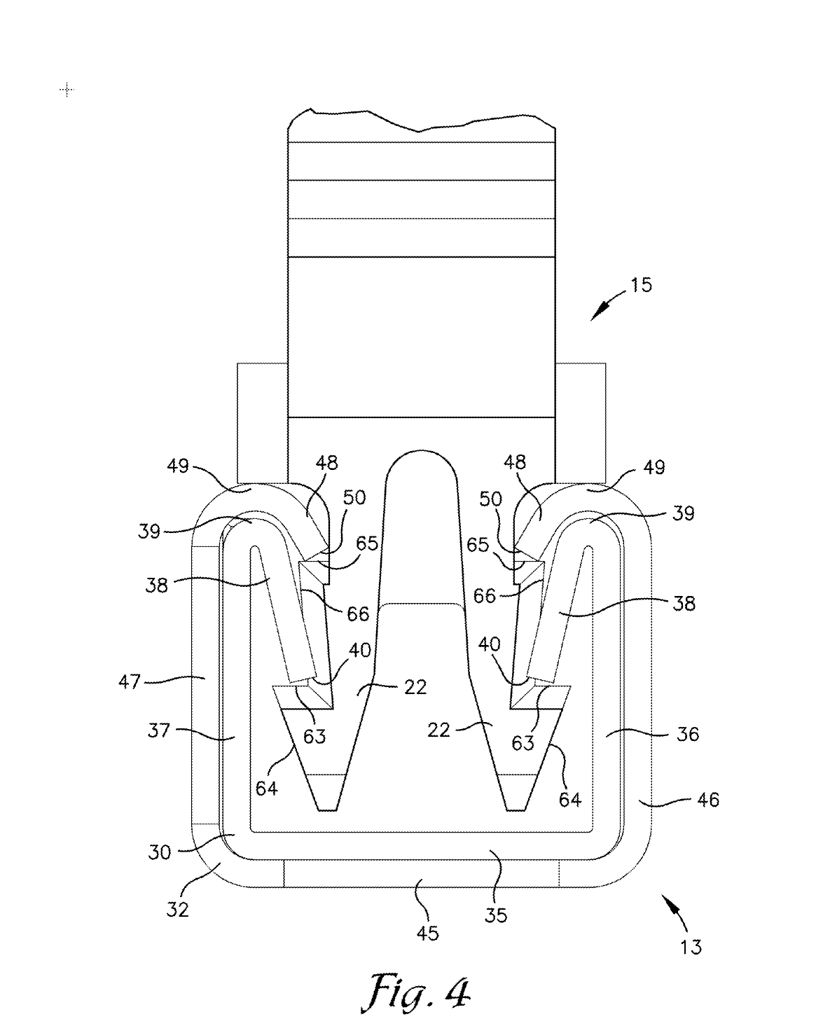

Installing the clamp assemblies 12 into a slider bracket 13 includes loading the base member 15 of each clamp assembly 12 into the slider bracket 13. The first and second depending legs 22 extend in spaced apart relation from each other and are inwardly flexible, with each leg 22 including opposing lower abutment features, shoulders, or steps 61 configured to engage or abut against the engagement features 38 of the inner bracket section 30 and opposing upper abutment features, shoulders, or steps 62 configured to engage or abut against the engagement features 48 of the outer bracket section 32. The lower and upper abutment features 61 and 62 are similarly formed, with the lower abutment features 61 having top surfaces 63 and tapered contact surfaces 64, and the upper abutment features 62 having top surfaces 65 and tapered contact surfaces 66. The top surfaces 63 and 65 extend outward and downward at slight angles with the top surfaces 63 extending further outward than the top surfaces 65 (see FIG. 4), and the tapered surfaces 64 and 66 extend downward and inward at relatively severe angles from their respective top surfaces 63 and 65. As best shown in FIG. 3, the upper shoulders 62 extend lengthwise along the entire clamp base frame 21, with downward-facing abutments 67 formed on the portions of the upper shoulders 62 which are oriented between the depending legs 22.

The loading of each base member 15 into a slider bracket 13 is preferably accomplished by applying force to the base members 15 to drive the first and second depending legs 22 thereof downward (with reference to the orientation shown in FIG. 2) into the channels formed within the inner and outer bracket sections 30 and 32, such that the tapered surfaces 64 of the depending legs 22 slide along the flanges 48 of the outer bracket section 32 to compress the depending legs 22 inward until the tapered surfaces 64 disengage from the flanges 48, at which point the depending legs 22 expand slightly outward such that the tapered surfaces 64 contact the flanges 38 of the inner bracket section 30 and the tapered surfaces 66 contact the flanges 48 of the outer bracket section 32. The depending legs 22 are driven further downward into the channels of the slider bracket 13, with the tapered surfaces 64 sliding along the flanges 38 and the tapered surfaces 66 sliding along the flanges 48 to compress the depending legs 22 back inward until the tapered surfaces 64 and 66 disengage from the flanges 38 and 48, respectively, and the depending legs 22 expand outward. The base members 15 are thus snapped into the slider bracket 13 and securely held in place therein, with the lower abutment features 61 of the depending legs 22 engaging the inner edges 40 of the flanges 38 of the inner bracket section 30 and the upper abutment features 62 of the depending legs 22 engaging the downwardly oriented edges 50 of the flanges 48 of the outer bracket section 32.

It is understood that the foregoing description of loading base members 15 into the slider bracket 13 is made with reference to a slider bracket 13 oriented with the inner bracket section 30 telescoped within the outer bracket section 32 as shown in FIG. 2, and that in embodiments where the inner and outer bracket sections 30 and 32 are telescoped away from each other, the tapered surfaces 64 and 66 will slide along the flanges 38 or the flanges 48 as the first and second legs 22 of the base members 15 are driven into the access channel of the inner or outer bracket section 30 or 32. Thus, the lower steps 61 securely hold the base members 15 in place within the slider bracket 13 at portions where the inner bracket section 30 is telescoped away from the outer bracket section 32, and the upper steps 62 securely hold the base members 15 in place within the slider bracket 13 at portions where the outer bracket section 32 is telescoped away from the inner bracket section 30.

Referring to FIG. 2, at least one of the base members 15 is loaded into the slider bracket 13 with a bag or container 26 situated therebetween. The bag 26 includes a first portion 68 and a second portion 69, with the clamp base frame 21 and the legs 22 of the base member 15 cooperating to removably secure the first portion 68 into the inner bracket section 30 or the outer bracket section 32 of the slider bracket 13. The container 26 may be a bag formed of a common flexible plastic such as low-density polyethylene (LDPE) or linear-low density polyethylene (LLDPE), the gauge of which is relatively thin such that when the first and second legs 22 depress the first portion 68 of the container 26 into the channels formed in the slider bracket 13, the container 26 does not interfere with engagement of the lower abutment features 61 and the engagement features 38, or with engagement of the upper abutment features 62 and the engagement features 48. The depending legs 22 may foreseeably pierce portions of the container 26 rather than forcing the container 26 into the channels formed in the slider bracket 13; when such piercing occurs, the clamp base frame 21 holds the container 26 against the upper edges of the inner bracket section 30 or the outer bracket section 32. It is to be understood that containers 26 other than bags, including pouches, sacks, and other generally flexible containers, may be used to hold the clamp assembly elements.

The second portion 69 of the container 26 holds pre-determined quantities of the clamp assembly elements, with the pre-determined quantities generally corresponding to the number of clamp assemblies 12 intended to be installed in a slider bracket 13, which may vary depending on application-specific factors including the dimensions of the mounting site (e.g., the distance between wall studs 14 or other adjacent building members) and the sizes and orientations of the clamp assemblies 12, slider bracket 13, and pipes 20. In the embodiment of the pipe support apparatus 11 shown and described herein, each clamp assembly 12 comprises one base member 15, one resilient insert 17, and one keeper block 19, and each slider bracket 13 is fastened to wall studs 14 by two or four screws 27. Thus, the pre-determined quantity of assembly elements held in the container 26 may foreseeably comprise either two or four screws 27 and quantities of resilient inserts 17 and keeper blocks 19 equal to the number of base members 15 positioned in the slider bracket 13. It should be understood, however, that the foregoing represents only one of many foreseeable ways in which the number of clamp assembly elements held in the container 26 can be pre-determined, and that the container 26 may contain virtually any quantity of resilient inserts 17, keeper blocks 19, screws 27, and other elements without departing from the scope of embodiments described herein.

Referring to FIG. 3, each of the elongated ratcheting arms 23a and 23b extending upward from the clamp base frame 21 include a plurality of ratchet teeth 71 formed along an outer surface thereof. The clamp base frame 21 includes a pair of upstanding walls 73a and 73b having opposing sliding surfaces 74a and 74b which face inward toward the central aperture 24, and recesses or notches 75a and 75b which are configured to cradle the pipe 20. The upstanding walls 73a and 73b are positioned on opposite sides of the central aperture 24 and may be referred to as first and second walls 73a and 73b, and the sliding surfaces 74a, 74b and notches 75a, 75b may be referred to as first and second sliding surfaces 74a and 74b and first and second notches 75a and 75b, respectively. It is foreseen that the notches 75a and 75b may have substantially U-shaped, V-shaped, or semicircular configurations.

The resilient insert 17 is preferably made of a flexible material such as Santoprene™ that is compatible for use with all types of plastic used in plumbing applications, including CPVC (chlorinated polyvinyl chloride). The resilient insert 17 is advanced into the base member 15 during installation of the clamp assemblies 12 and is sized to be received within the central receiver 24, with the thickness of the resilient insert 17 generally corresponding to the width of the central receiver 24 such that the distance between opposingly facing first and second surfaces 81a and 81b of the resilient insert 17 is approximately equal to, or less than, the distance between the first and second sliding surfaces 74a and 74b of the upstanding walls 73a and 73b. Thus, the first and second surfaces 81a and 81b may slide along the first and second sliding surfaces 74a and 74bas the resilient insert 17 is advanced into the base member 15. The resilient insert 17 extends upward from a generally flat bottom surface 82 to a curved receiving surface or recess or notch 83 for receiving the pipe 20, with the curved receiving surface 83 having a shape that matches but extends slightly above the notches 75a and 75b of the base member 15.

The resilient insert 17 includes a protrusion or protruding feature 25 which is oriented proximate the bottom edge or surface 82 and extends outward from the first surface 81a such that the distance between the second surface 81b and the protrusion 25 is greater than the distance between the first and second sliding surfaces 74a and 74b of the upstanding walls 73a and 73b . With the combined thickness of the resilient insert 17 and the protruding feature 25 protruding therefrom exceeding the width of the central receiver 24, the protrusion 25 frictionally engages with the first upstanding wall 73a upon advancement of the resilient insert 17 into the central receiver 24.

When the resilient insert 17 is forced downward to be received within the central aperture 24, the first wall 73a compresses the protrusion 25 inward and forces the resilient insert 17 toward the second wall 73b such that the second surface 81b of the resilient insert 17 slides along the second sliding surface 74b and the protrusion 25 slides along the first sliding surface 74a with the first surface 81a of the resilient insert 17 slightly spaced apart therefrom. As the resilient insert 17 is forced further downward and the bottom surface 82 thereof approaches and comes into contact with the floor 35 of the inner bracket section 30 or the floor 45 of the outer bracket section 32, the protrusion 25 concomitantly extends past the first sliding surface 74a and expands outward to engage with a lower surface of the abutment 67 such that the protrusion 25 and the abutment 67 cooperate to retain the resilient insert 17 within the central aperture 24.

The protruding feature 25 shown in FIG. 3 is a generally solid triangular wedge including an inclined sloping surface 84 that slopes upward and outward from the bottom surface 82 to a generally flat, upward-facing abutment 85 which engages a lower surface of the abutment 67 when the resilient insert 17 is advanced into the base member 15. It should be understood, however, that the protruding feature 25 may comprise various other geometries and/or configurations without departing from the scope of embodiments of the invention described herein. For example, it is foreseen that the protruding feature 25 may comprise an elongated wedge or a plurality of truncated wedges (one or more of which may include hollows or recesses to minimize material usage), or that the protruding feature 25 may comprise one or more nubs which may be generally hemispherical. Further, although the foregoing description is provided with reference to the protruding feature 25 being formed on the first surface 81a of resilient insert 17, it is foreseen that the protruding feature 25 may alternatively or additionally extend outward from the second surface 81b of the resilient insert 17.

Each keeper block 19 includes a keeper block plate 90 with a pair of arm receiving apertures 91a and 91b extending therethrough and oriented near respective opposite ends of the keeper block plate 90, each receiving aperture 91a, 91b sized to receive a respective ratchet arm 23a, 23b. Each of the arm receiving apertures 91a, 91b is defined by an inner anvil surface 92 and a respective pawl member 93 which is positioned within and hingedly attached to an outside wall of the keeper block 19. Each pawl member 93 includes a series of teeth 94 which are closely spaced apart to engage the corresponding ratchet teeth 71 on the respective ratchet arm 23a or 23b extending through the respective arm receiving aperture 91a, 91b. Each pawl member 93 is molded in a manner such that it is elastically urged toward the corresponding anvil surface 92 so that the ratchet teeth 71 are captured by the teeth 94 of the pawl member 93. Each pawl member 93 includes an extension 95 which protrudes upward from the keeper block plate 90 and may be pushed outwardly to disengage the pawl member teeth 94 from the ratchet teeth 71, thereby releasing the ratchet arms 23a and 23b.

The keeper block 19 includes a pair of keeper block walls 96 positioned along respective sides of the keeper block plate 90, with each keeper block wall 96 including a notch 97. As with the notches 75a and 75b of the base member 15, the notches 97 may foreseeably have a substantially U-shaped, V-shaped, or semicircular configuration. In use, the keeper block 19 is ratcheted downward along the ratchet arms 23a and 23b such that the keeper block notches 97 are positioned in opposition to the base member notches 75a and 75b to cradle the pipe 20 therebetween.

As the keeper block 19 is ratcheted downward on the ratchet arms 23a and 23b and against the pipe 20, the curved receiving surface 83 of the resilient insert 17 is forced downward toward the central aperture 24, with the resilient insert 17 compressing sufficiently for the curved receiving surface 83 to extend within the central aperture 24. Such downward movement of the resilient insert 17 forces the bottom surface 82 thereof to spread outwardly along the floor 35 of the inner bracket section 30. It is understood that in portions of the slider bracket 13 where the outer bracket section 32 is telescoped beyond the inner bracket section 30, the bottom surface 82 is forced downward to spread outwardly along the floor 45 of the outer bracket section 32. The outward spreading of the bottom surface 82 of the resilient insert 17 forces the clamp base member 15 upward such that the lower and upper gripping steps 61 and 62 engage the edges 40 and 50, respectively, thereby creating a spring action that securely holds the installed clamp assembly 12 into place.

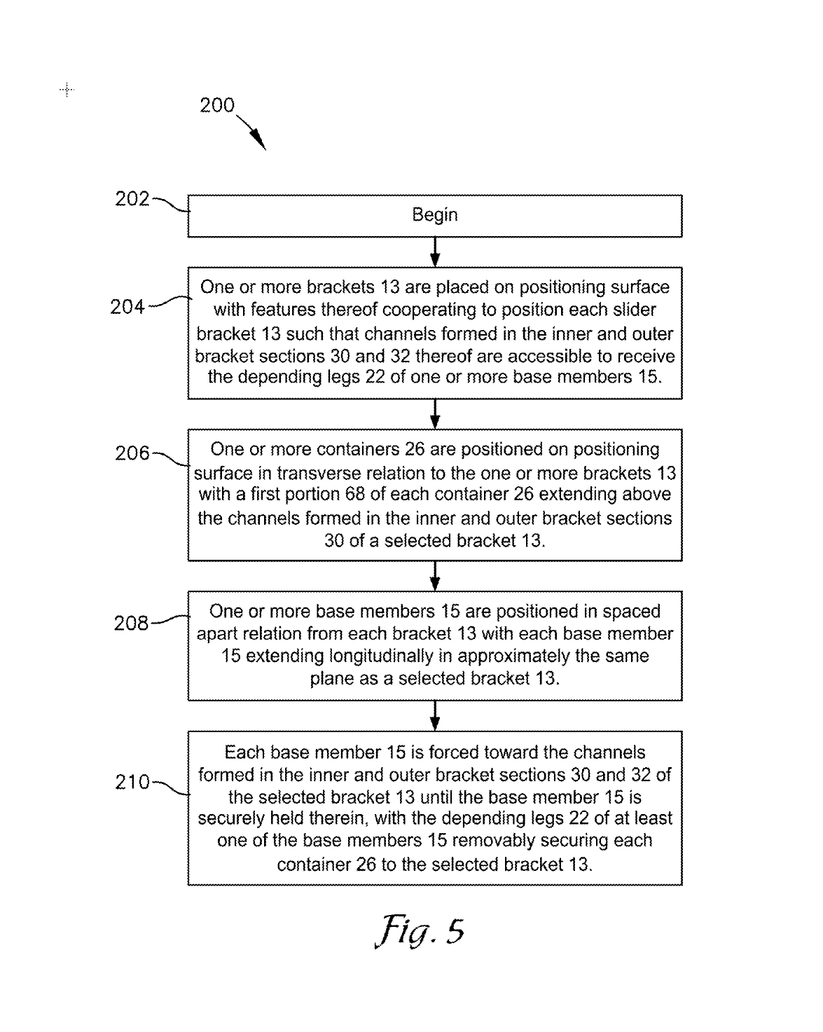

A process of assembling the pipe support apparatus 11 is now described in accordance with an embodiment of the invention. FIG. 5 is a flowchart outlining a method 200 illustrating steps for performing the process of assembling the pipe support apparatus 11 for distribution. These steps are described relative to a clamp assembly base member 15 and a plumbing slider bracket 13, and are preferably carried out autonomously or generally autonomously using one more or more processors and machine-readable instructions executed thereby to direct robotic processes, which preferably include articulated, cartesian, cylindrical, SCARA, and/or delta robots, one or more of which may be equipped with gripping means and/or actuators for manipulating elements of the pipe support apparatus 11. It is understood, however, that the steps could be carried out manually or by hand-operated devices such as arbor presses, and that the steps could be applied to other types of clamping members or brackets.

The method may begin at step 202. At step 204, one or more slider brackets 13 are positioned in a fixture (not shown) including a generally flat positioning surface that may include features such as locators, receptacles, positioning magnets, proximity sensors, actuatable clamps, and the like to define positions for the slider brackets 13 and facilitate repeatable positioning thereof. In an embodiment, the positioning surface extends in an approximately horizontal plane, but it is foreseen that the positioning surface may extend in an approximately vertical plane. The slider brackets 13 are positioned such that the channels formed in the inner and outer bracket sections 30 and 32 thereof are accessible to receive the first and second legs 22 of one or more base members 15. In embodiments where the fixture is configured for positioning a plurality of slider brackets 13, the features of the positioning surface are oriented such that the slider brackets 13 positioned thereon are spaced apart from one another at distances sufficient to accommodate positioning of the containers 26 as described below with reference to step 206. It is understood that the slider brackets 13 may be positioned in the fixture with the inner bracket sections 30 fully telescoped within the outer bracket sections 32, or with the inner and outer bracket sections 30 and 32 partially or fully telescoped away from each other.

At step 206, one or more containers 26 having respective pre-determined quantities of clamp assembly elements contained therein are positioned on the positioning surface of the fixture such that the first portion 68 of each container 26 lies across the extremities 49 of a selected slider bracket 13 and extends just above the channels formed in the inner and outer bracket sections 30 and 32 thereof. Each container 26 is preferably positioned to extend transverse to a selected slider bracket 13, with the second portion 69 of each container 26 and the clamp assembly elements held therein laying on the positioning surface in spaced apart relation from the selected slider bracket 13 and any adjacent slider brackets 13, thereby minimizing the risk of the clamp assembly elements being damaged during the assembly process.

At step 208, one or more base members 15 are loaded into each slider bracket 13 by positioning each base member 15 above a selected slider bracket 13 and in spaced apart relation therefrom, such that the base member 15 and the selected slider bracket 13 extend longitudinally in approximately the same vertical plane. With the one or more base members 15 so oriented, at step 210 each base member 15 is forced downward to drive the depending legs 22 thereof into the channels formed in the inner and outer bracket sections 30 and 32 of the selected slider bracket 13 until the base member 15 is securely held within the slider bracket 13. At least one of the base members 15 is forced downward onto the first portion 68 of the container 26, with the depending legs 22 thereof depressing the first portion 68 into the channels formed in the inner and outer bracket sections 30 and 32, and the clamp base frame 21 and depending legs 22 of the base member 15 removably securing the container 26 to the selected slider bracket 13. A tooling (not shown) may be provided for loading the base members 15 into the slider brackets 13. The tooling may foreseeably include receptacle features into which the base members 15 are positioned for loading, and may also include actuators or other force-generating devices for forcing the depending legs 22 of the base members 15 into the slider brackets 13.

Many different arrangements of the various components depicted, as well as components not shown, are possible without departing from the scope of the claims below. For example, while the pipe support apparatus 11 has been described and illustrated for use with plumbing pipes, it can be equally useful with electrical or communications cables or conduits, fiber optic bundles, wire bundles, or virtually any other elongate structure to be routed through a building structure, therefore, the terms “pipe” and “plumbing” are intended for illustrated purposes only and are not intended to be limiting.

Embodiments of the technology have been described with the intent to be illustrative rather than restrictive. Alternative embodiments will become apparent to readers of this disclosure after and because of reading it. Alternative means of implementing the aforementioned can be completed without departing from the scope of the claims below. Identification of structures as being configured to perform a particular function in this disclosure is intended to demarcate those structures as including a plurality of possible arrangements or designs within the scope of the disclosure and readily identifiable by one of skill in the art to perform the particular function in a similar way without specifically listing all such arrangements or designs. Certain features and sub-combinations are of utility and may be employed without reference to other features and sub-combinations and are contemplated within the scope of the claims.

As used in the claims, identification of an element with an indefinite are “a” or “an” or the phrase “at least one” is intended to cover any device or assembly including one or more of the elements at issue, Similarly, references to first and second elements, or to a pair of elements, is not intended to limit the claims to such assemblies including only two of the elements, but rather is intended to cover two or more of the elements at issue. Only where limiting language such as “a single” or “only one” with reference to an element, is the language intended to be limited to one of the elements specified, or any other similar limited number of elements.

What is claimed is:

1. A pipe clamp engageable with a mounting bracket for supporting plumbing pipes, the pipe clamp comprising:
a base member having a central receiver and first and second legs extending in spaced apart relation, each of the first and second legs having an abutment feature extending outwardly therefrom, the central receiver extending through the base member and between the first and second legs;
a keeper block engageable with the base member; and
a resilient insert having a protruding feature extending outward therefrom, the resilient insert advanceable into the central receiver, the protruding feature engageable with the base member.

2. The pipe clamp as in claim 1, in combination with a mounting bracket including first and second sidewalls defining a channel and first and second engagement features extending inward from the respective first and second sidewalls, the base member configured to be loaded into the mounting bracket such that the first and second abutment features of the base member are engageable by the first and second engagement features of the mounting bracket.

3. The pipe clamp as in claim 2, wherein the mounting bracket comprises a first bracket section and the pipe clamp further comprises a second bracket section, the first bracket section slidable to fit within the second bracket section.

4. The pipe clamp as in claim 1, wherein the resilient insert includes opposing first and second surfaces, wherein a thickness of the resilient insert between the opposing first and second surfaces is approximately equal to or less than a width of the central receiver such that the resilient insert is advanceable within the central receiver of the base member as the resilient insert is loaded within the central receiver.

5. The pipe clamp as in claim 4, wherein the protruding feature protrudes outward from at least one of the opposing first and second surfaces such that a thickness of the resilient insert between the opposing first and second surfaces and at least a portion of the protruding feature exceeds the width of the central receiver.

6. The pipe clamp as in claim 1, wherein the protruding feature is formed proximate a bottom surface of the resilient insert.

7. The pipe clamp as in claim 6, wherein the resilient insert includes a curved receiving surface opposite the bottom surface.

8. The pipe clamp as in claim 1, wherein the protruding feature comprises a wedge having a sloping surface extending upward and outward from the resilient insert.

9. The pipe clamp as in claim 1, further comprising a parts-containing bag positioned between the mounting bracket and the pipe clamp, the parts-containing bag containing a plurality of clamp assembly elements.

10. A pipe support apparatus comprising:
a mounting bracket including first and second sidewalls with first and second engagement features formed respectively thereon, the first and second sidewalls defining a channel;
a flexible container having a first portion and a second portion, the second portion containing one or more clamp assembly elements; and
one or more clamp base members, each clamp base member including first and second legs having first and second abutment features formed respectively thereon, the first and second legs compressible by the first and second sidewalls, and the first and second abutment features engageable with the first and second engagement features, respectively; wherein:
the first portion of the flexible container is positioned within the channel of the mounting bracket between a floor of the mounting bracket and the first and second legs.

11. The pipe support apparatus as in claim 10, wherein the mounting bracket comprises a first bracket section and the pipe support apparatus further comprises a second bracket section, the first bracket section and the second bracket section telescopically extendable and retractable relative to each other.

12. The pipe support apparatus as in claim 10, wherein the one or more clamp assembly elements contained in the second portion include a plurality of resilient inserts and a plurality of keeper blocks.

13. The pipe support apparatus as in claim 10, wherein the one or more clamp assembly elements is a pre-determined number of clamp assembly elements corresponding to a number of clamp base members loaded into the mounting bracket.

14. The pipe support apparatus as in claim 10, wherein the first portion extends between the first and second sidewalls of the mounting bracket.

15. The pipe support apparatus as in claim 10, wherein the second portion is spaced apart from the one or more clamp base members.

16. A method of assembling a support apparatus to be distributed with one or more assembly elements, the method comprising:
positioning one or more brackets on a positioning surface, wherein each bracket includes first and second sidewalls forming a channel therebetween, and the positioning surface includes one or more features for positioning the one or more brackets with the channels accessible to receive one or more base members;
positioning one or more containers on the positioning surface with the one or more containers extending generally transverse to the one or more brackets, wherein a first portion of each container extends across at least one of the first and second sidewalls and adjacent to the channel of a corresponding bracket, and a second portion of each container holds a plurality of assembly elements; and
loading one or more base members into each bracket, each base member including depending legs engageable with of the first and second sidewalls of the brackets, wherein the depending legs of at least one of the base members depress the first portion of a corresponding container into the channel of a corresponding bracket.
